(19) United States
(12) Patent Application Publication
(10) Pub. No.: US 2014/0297419 A1
(43) Pub. Date: Oct. 2, 2014

(54) METHOD AND SYSTEM FOR INSERTING TARGETED ADVERTISEMENT BY MOBILE NETWORK OPERATORS THROUGH WEBSITE CUE TONES

(71) Applicant: PRAKASHA MANDAGARU RAMACHANDRA, (US)

(72) Inventor: PRAKASHA MANDAGARU RAMACHANDRA, (US)

(21) Appl. No.: 13/854,093

(22) Filed: Mar. 31, 2013

(51) Int. Cl. G06Q 30/02

(52) U.S. Cl. CPC G06Q 30/0267
USPC 705/14.64

(57) ABSTRACT

The present invention describes a method for inserting targeted advertisement content by a last mile operator (typically a Mobile Network Operator (MNO)) onto websites accessed through its network and this websites has placeholder or cue tone for inserting advertisement by last mile operator. The invention also enables parsing of the placeholder or website cue tone by MNOs, wherein such placeholders being created on website to allow advertising content placing by participating MNOs. The MNOs can either use Internet ad service platform like Google AdSense or use their own advertisement serving platform to replace website cue tone with advertisement content in HTTP response and such HTTP response is passed onto its subscribers. This method allows subscribers to receive content from website publisher and targeted advertisement content from MNOs.

### BACKGROUND

1. Field of the invention

Embodiments of the present invention generally relate to the field of Computer Sciences and, more particularly, to a method and system to create dedicated placeholder or cue tone in websites, so that the last mile operator's network that enables publishing of these website can insert targeted advertisements rather than the advertisements decided by the website publishers. This allows last mile operators to generate additional revenue and hence monetize the network resources that are used for accessing these websites.

2. Description of the Related Art

Any website (www) which publishes content can be accessed by using variety of end points, such as Desktops or PDAs or Smart-phones. More and more websites are now accessed using Smart Phones through an inter-mediatory network operator, also called Mobile Network Operator (“MNO”). The Mobile Network Operator is defined to include any Last Mile Operator, such as Internet Service Provider (ISPs), Fixed Line (PSTN) Network Operators and Mobile Operators. This last mile operator is responsible for routing all requests from Users to the website published by a Content Owner. At present the content owner controls publishing of targeted advertisements to the Users when such website access requests are serviced.

The same concept happens in the Broadcasting industry, and a Cue tone is created in the video signals to help the broadcasters to insert localized targeted advertisements to the viewers. The targeted advertising is the selection of video advertisements for insertion into scheduled television programming, in such a manner, as to match the advertisement to an individual viewer's interest profile. Inserting a dedicated placeholder in the form of cue tone is a normal practice in TV broadcasting, where the content owners provide this placeholder for broadcasters to insert local advertisement in the content before this content gets broadcast onto the TV content distribution network. Right now there is no similar mechanism in Internet wherein last mile operator can insert localized advertisement in the published website. So if the last mile operator wants to further increase revenue from flat rate Internet access it is providing to its subscribers, there is no standard way for it to include advertisements/modify advertisements according to local environment/regulation. Hence, it creates tension between the last mile operator and the website owners or the content aggregators like Google.

Since network operators (mostly mobile operators) are increasingly feeling that they are becoming dumb pipe, they are taking help from Government to convince companies like Google to compensate for the increased data traffic burden. E.g., recently France operator Orange made Google to agree to share its advertisement revenue. However, revenue sharing is not the solution due to a different regulatory environment prevailing in each country. Even, for example, Google shares revenue with Orange on advertisement, still the control for advertisement remains with Google (a company governed by US laws) and it may result in displaying an advertisement that is non-compliant in hosting country.

FIG. 1 is a block diagram depicting existing structure of providing targeted Ads for TV users, according to the existing related art. For example, there is main program that is viewed either by young people or by a family. At present the viewership can be divided in the audience segment of “Young” people or “family”. During a break, if a car advertisement has to be shown to “young” audience, a sports car advertisement can be shown. Similarly for a “family” audience, an SUV or sedan car advertisement can be shown. The targeted advertisement insertion can be done either by the content provider or the broadcaster.

FIG. 2 is a flow chart that depicts the Ad Insertion mechanism, according to the existing related art. This figure shows how an ad insertion system works in a TV network. This diagram shows that the program media is received and a cue tone indicates the beginning of an advertising spot. When the IP Router receives the cue tone, it informs the Ad Server that an ad is required and the Ad Server matches the group ad requirements to specific advertising messages. These messages are associated with group identification codes that are sent to the Ad Splicer which splices (attaches) each ad to the appropriate media stream. The resulting streams are sent through the IP router to their appropriate recipients.

FIG. 3 is a block diagram that depicts the existing ecosystem of providing the targeted advertisement through the services of Internet Ad network operator, according to the existing related art. Typically, a website owner, also known as Publisher in the ad industry has an account with a Google Ad service (here Google Ad service is taken only as an example; website publisher can invoke any other Internet ad network service provider). The website owner will include Google specific HTML/Java Script code in their webpage source. Brands/media agencies would buy space and enter into agreement with Google on business model—pay based on impression, click-through-rate, etc. Google as representative ad network operator will insert an ad that will be seen by the end user. When the end user accesses any website, last mile network operator's only role is to provide the last mile connectivity. Even though these network operators may charge a flat monthly rate for maintaining high Quality of Service (QOS) for the data pipe, it is not a strong motivator for these operators to maintain high Quality of Experience (QOE) for such services.

Our search at US & European Patent Database reveals several pending and issued patents relating to the insertion of advertisements by content owners. U.S. Pat. No. 6,925,469 by Kevin P. Headings et al is titled as DIGITAL ENTERTAINMENT SERVICE PLATFORM. The invention is directed to an open business platform that provides an end-to-end solution for managing, distributing, and/or retailing digital media assets from various content suppliers.

European Publication Patent No. EP2308187 A1 by Andrew Fife et al is titled as SYSTEMS AND METHODS FOR DYNAMIC BANDWIDTH ALLOCATION FOR ADDRESSABLE CONTENT. The invention describes a push-based dynamic bandwidth allocation deliver addressable, advertising content in a digital network. Bandwidth is allocated on a push basis in response to receiving a cue tone from a broadcast stream and the cue tone contains data indicating an addressable break. European Publication Patent No. EP1051848 B1 by Reem Safadi is titled as APPARATUS AND METHOD FOR DIGITAL ADVERTISEMENT INSERTION IN A BITSTREAM. The invention is a system for inserting commercials into an audiovisual bit stream by providing cue commands in response to cue tones in a pre-existing analog signal, and/or in response to control signals from an uplink (/programmer/network) site or headend. European Publication Patent No. EP 2415188 A1 by Jenny Bridges et al is titled as METHOD AND SYSTEM FOR MANAGING TELEVISION ADVERTS IN TIME SHIFTED BROADCAST CONTENT. Embodiments of the invention provide a method of removing or replacing advertisement slots in linear broadcast television programming when replayed as a time-shifted television asset, comprising capturing an input linear broadcast video stream to form a time-shifted television asset.

Despite the existence of several related art, the challenge still remains to empower MNOs to place localized and targeted advertisements on its User Base that are accessing websites and contents over the Internet.

### SUMMARY OF THE INVENTION

Aspect of the present invention is to provide for a mechanism for mobile Network Operator who owns the last mile, to insert advertisement content on websites as per its choice for the targeted audience and in a manner that helps all the actors involved in the Internet ecosystem.

Another aspect of the present invention is to enable a mobile network operator (MNO) to further supplement revenue from the existing flat rate Internet access to the one based on providing targeted advertisement to its subscribers.

One more aspect of the present invention is to provide a standard way for the MNOs to include advertisements/modify advertisements according to local environment/regulation.

One more aspect of the invention is to provide a dedicated section in websites created by website owners, so that the network that enables publishing of this website, can insert targeted advertisements.

Another aspect of the invention is to enable the publishing website owner to insert a ‘cue tone’ like placeholder section in the website by adding an appropriate HTML DIV section.

Another aspect of the invention to enable the last mile operator to invoke services of Internet Ad network operator, like Google AdSense or others to provide advertisements.

One more aspect of the invention is to enable the last mile operator to provide ad platform which they may be using for inserting advertisements from the ad serving platform currently being used for other telecom publishing channels (e.g., ring back tone or SMS or MMS).

Other aspects, advantages, and salient features of the invention will become apparent to those skilled in the art from the following detailed description, which, taken in conjunction with the annexed drawings, disclose exemplary embodiments of the invention.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram depicting existing structure of providing targeted Ads for TV users, according to the existing related art.

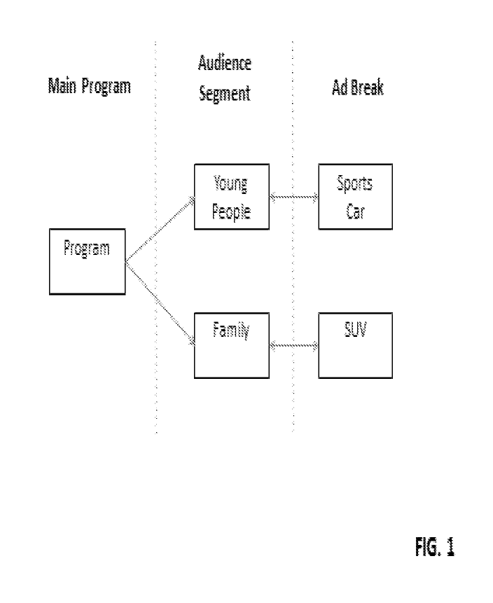

FIG. 2 is a flow chart that depicts the Ad Insertion mechanism, according to the existing related art.

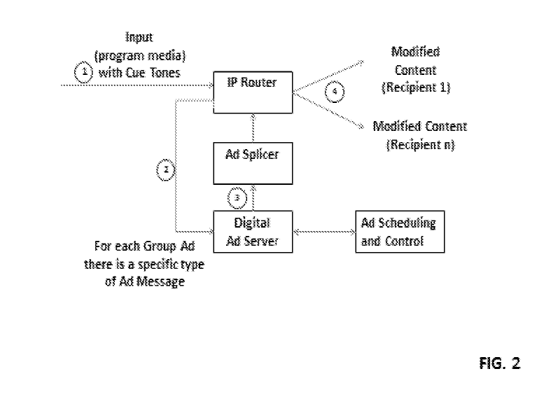

FIG. 3 is a block diagram that depicts the existing ecosystem of providing the targeted advertisement through the services of Internet Ad network operator, according to the existing related art.

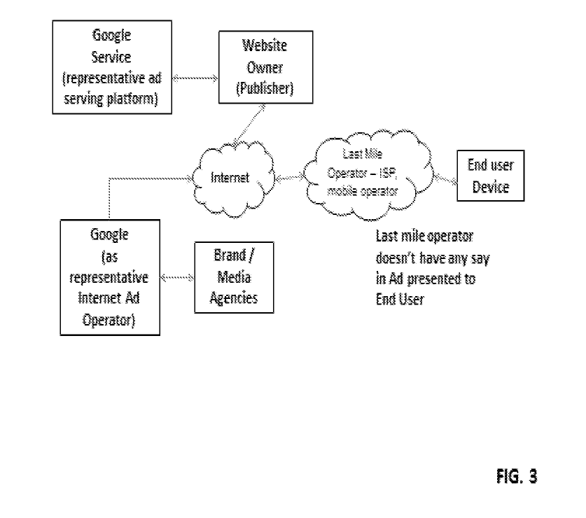

FIG. 4 is a block diagram that depicts the modified ecosystem of providing targeted advertisement, according to one or more embodiments of the present invention.

FIG. 5 is a flowchart that depicts the steps of sending request, according to one or more embodiments of the present invention.

FIG. 6 is a flowchart that depicts the steps of receiving request, according to one or more embodiments of the present invention.

FIG. 7 is a block diagram that depicts the targeted ad insertion process based on end point profile, according to one or more embodiments of the present invention.

### DETAILED DESCRIPTION

In the present description, some words are being used interchangeably to mean the same thing/entity: ‘Customers’ & ‘Users’; ‘He’ & “She”, ‘Last Mile Operator’ & ‘Mobile Network Operator’; ‘Subscribers’ & ‘End Users’.

It is appreciated that present invention can be implemented in a variety of systems, devices, architectures and configurations. For example, it can be used as an application with several known platforms, such as for, mobile platforms (iPhone, iPad, Android, Windows), distributed computing environment, a cloud computing environment, a client server environment, social networking websites, etc. Embodiments described herein may be discussed in the general context of computer-executable instructions residing on some form of computer-readable storage medium, such as program modules, executed by one or more computers, computing devices, or other devices.

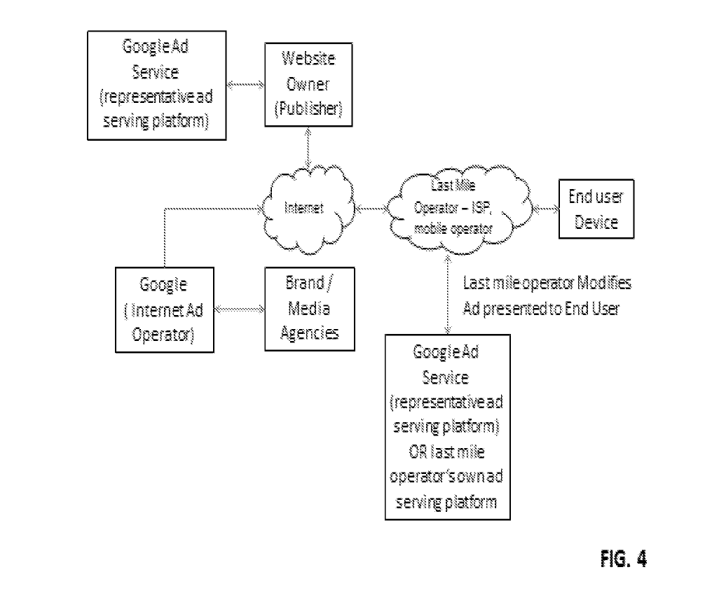

FIG. 4 is a block diagram that depicts the modified ecosystem for providing targeted advertisement, according to one or more embodiments of the present invention. In this case, publishing website owner inserts a ‘cue tone’ like placeholder section in the website by adding an appropriate Hyper text markup language, HTML DIV id or class name that provides container for advertisements in the web page. HTML div element is a generic mechanism that allows creating custom structure or groupings of elements but it can be styled with Cascading Style Sheet (CSS) and manipulated via JavaScript. Although div don't add any semantic meaning, they could be considered to represent a structural division of the mark-up, along with the appropriate semantic class or ID name. As the div class and div id names should always be semantic and refer to the meaning/role of the content, the div name should reflect that it is the placeholder for intermediary advertisements. Example names could be intermediary_ads or website_cuetone_ads etc. Also, the name used should be agreed by the parties involved in the ecosystem.

In order to insert the advertisement, last mile operator can either invoke services of Internet ad exchange networks like Google AdSense or can use their own ad platform which they may be using for inserting advertisement in other telecom channels (e.g., ring back tone or SMS or MMS)

Alternatively last mile network operator can choose to track the advertisement that is being sent to the end user and initiate revenue settlement with the Internet ad network operators.

HTTP response reaches end user browser along with content provided by website owner and the advertisement inserted by the last mile operator

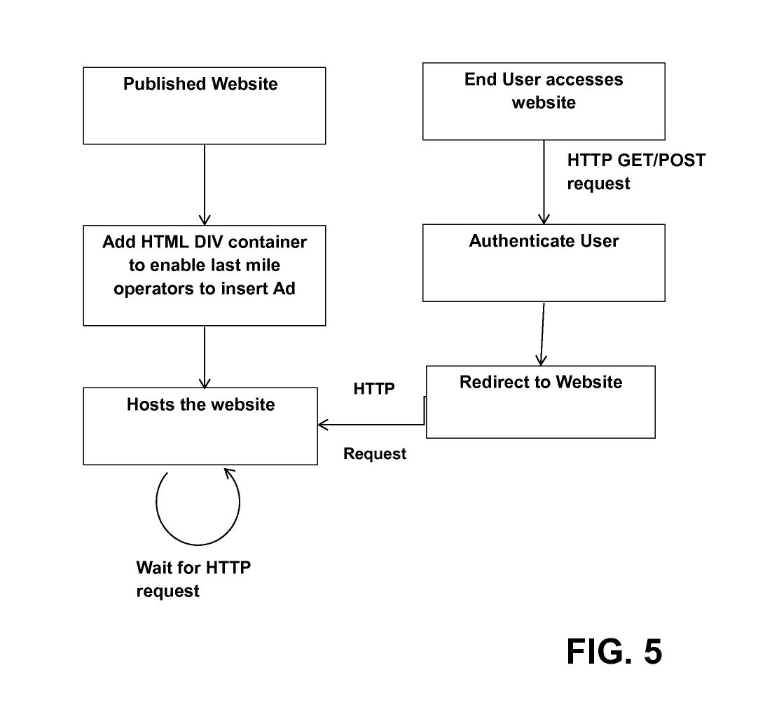

FIG. 5 is a flowchart that depicts the steps of sending request, according to one or more embodiments of the present invention. Website owner designs & develops website. During HTML coding, the website owner can insert div container for inserting ad by the last mile operator. When the end user goes to the URL or clicks on a link to initiate session with website, the last mile operator authenticates user. It also applies necessary policy on the user account, access control list, etc. Thereafter, it performs necessary DNS resolution and route request to website owner's server. An HTTP request is send to the hosting website in a server that handles requests from end users.

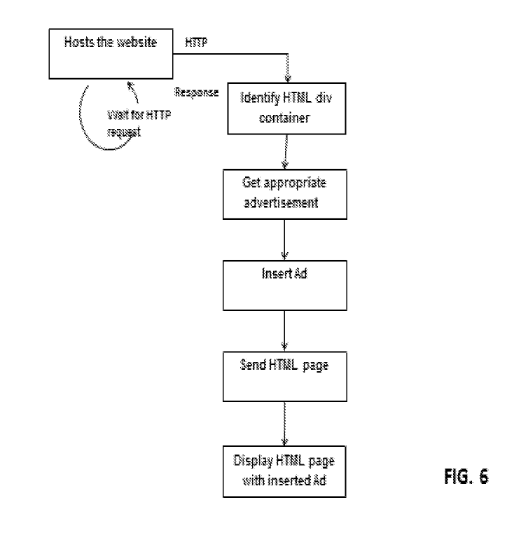

FIG. 6 is a flowchart that depicts the steps of receiving request, according to one or more embodiments of the present invention. The website is hosted on a server that handles HTTP requests from end users. The last mile operator's Deep Packet Inspection (DPI) engine parses for div container that allows inserting ad in HTML document in HTTP response message. The last mile operator accesses the advertisement platform to get appropriate advertisement link, updates div container with advertisement URL and passes the HTTP response to end user. The end user browser receive HTTP response with HTML page and the browser displays website owner content as well as advertisement inserted by last mile operator

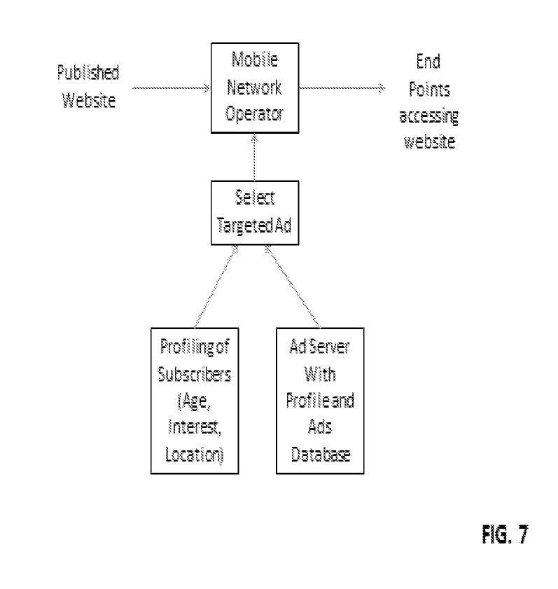

FIG. 7 is a block diagram that depicts the targeted ad insertion process based on end point profile, according to one or more embodiments of the present invention. Over a period of time, MNO can build a strong database of profiles of its subscribers. It certainly has a lot of information at the time when a subscriber takes the services of MNO, and thereafter, it can observe pattern over a period of time to know the habits and interest of the subscribers. Additional information, like age, gender, location, culture, profession, etc can also be easily obtained by a MNO. All the advertisements or contents then need to be targeted and focused, in order to produce maximum results for the advertisers. The advertiser can specify a profile for which the advertisement should be targeted. When a request to display a certain advertisement is received by MNO, the same can be classified based on the profiled database with MNO. A special alert can also be given that such an advertisement does not comply with local regulations of the region in which subscribers may be based.

While the foregoing is directed to embodiments of the present invention, other and further embodiments of the invention may be devised without departing from the basic scope thereof, and the scope thereof is determined by the claims that follow.

1. A method for inserting targeted content by mobile network operator (MNO), such a method comprising the steps of:
creating a placeholder with an appropriate code on a website, such as to enable an MNO to insert its content;
allowing the subscribers of MNO to initiate contact with such website's hosted server as per the policies set up by MNO; and
accessing the website, with contents from such website, displayed along with contents provided by MNO,
so as to allow End Users to receive targeted advertisements upon accessing websites that contain such placeholders.

2. A method as recited in claim 1, wherein such a placeholder is a container for providing advertisement on a webpage that is enabled to hold website cue tone advertisement.

3. A method as recited in claim 2, wherein such a container is website cue tone with an appropriate HTML Div.

4. A method for inserting targeted content by mobile network operator (“MNO”), such a method comprising the steps of:
parsing of the placeholder by the MNO, such placeholder being created on website to allow content placing by the MNOs;
accessing the MNO's platform to get appropriate advertisement content;
updating the placeholder with such an advertisement content; and
passing HTTP response to an end user, so as to allow such End Users to receive targeted content upon accessing such website containing such placeholders.

5. A method as recited in claim 4, further comprising the steps of MNO invoking the services of Internet Ad exchange networks, like Google Adsense or any other of MNO's choice, to insert advertisement on accessed websites.

6. A method as recited in claim 4, further comprising the steps of MNO using its own ad platform used for inserting advertisements in other telecom publishing channels.

7. A method as recited in claim 4, wherein the targeted advertisements are sent based on the profiling of the subscribers by the MNO while delivering website cue tone advertisement.

8. A system to insert targeted content by mobile network operator (MNO), such a system comprising of:
a module to parse the placeholder by an MNO, such placeholder being created on website to allow content placing by MNO;
a module to access the MNO's platform to get appropriate content link;
a module to update the placeholder with such a content link to be passed over to an end user;
so as to allow such End Users to receive targeted content upon accessing such website containing such placeholders.

9. A system as recited in claim 8, further comprising of the MNO invoking the services of Internet ad exchange networks, like Google AdSense or any other of MNO's choice, to insert advertisement on accessed websites.

10. A system as recited in claim 8, further comprising of an ad platform used for inserting advertisements in other telecom publishing channels.

11. A system as recited in claim 8, wherein the targeted advertisements are sent based on the profiling of the subscribers by the MNO while delivering website cue tone advertisement.
